(19) United States
(12) Patent Application Publication
(10) Pub. No.: US 2013/0018588 A1
(43) Pub. Date: Jan. 17, 2013

(54) METHOD OF REAL TIME SUBSURFACE IMAGING USING GRAVITY AND/OR MAGNETIC DATA MEASURED FROM A MOVING PLATFORM

(71) Applicants: Michael S. Zhdanov, Holladay, UT (US); Glenn A. Wilson, Holladay, UT (US)

(72) Inventors: Michael S. Zhdanov, Holladay, UT (US); Glenn A. Wilson, Holladay, UT (US)

(73) Assignee: TECHNOLMAGING, LLC., Salt Lake City, UT (US)

(21) Appl. No.: 13/488,247

(22) Filed: Jun. 4, 2012

Related U.S. Application Data
(60) Provisional application No. 61/506,538, filed on Jul. 11, 2011.

(51) Int. Cl. G06F 19/00; G01V 3/08; G01V 7/00

(52) U.S. Cl. 702/11

(57) ABSTRACT

A method for rapid real time imaging of geological formations and/or man-made objects having density and/or magnetization is described, using gravity and/or magnetic scalar and/or vector and/or tensor data measured by a moving platform. The gravity and/or magnetic field sensors may measure gravity and/or magnetic data at the at least one receiver along the survey lines by the moving platform. The recorded data may be applied as an artificial source of the potential field to generate an evolving migration (backpropagating) field, and may be applied iteratively. An integrated sensitivity of the potential field to density and/or magnetization perturbation may be calculated. A spatial weighting of at least one of the evolving migration fields may form an evolving real time holographic image. At least one desired property of the medium may be derived providing real time reconstruction of the volume physical properties of the geological formations and/or man-made objects.

### CROSS-REFERENCE TO RELATED APPLICATIONS

This application claims the benefit of U.S. Provisional Application No. 61/506,538, filed Jul. 11, 2011, which is incorporated herein by reference in its entirety.

This application hereby incorporates U.S. Pat. No. 4,814,711 that issued in 1989 to Olsen and Petrick, U.S. Patent Publication No. 2011/0144472 to Zhdanov, and U.S. Pat. No. 6,253,100 that issued in 2001 to Zhdanov by reference each in their entireties. This application also hereby incorporates the following publications by reference in their entireties: Zhdanov, M. S., 1988, Integral transforms in geophysics: Springer Verlag; Zhdanov, M. S., X. Liu, and G. A. Wilson, 2010, Potential field migration for rapid 3D imaging of entire gravity gradiometry surveys: First Break, 28 (11), 47-51.

### BACKGROUND OF THE INVENTION

1. The Field of the Invention

The present disclosure relates in general to the real time imaging of density and/or magnetization using devices that measure gravity and/or magnetic data, including scalar and/or vector and/or tensor fields, from moving platforms.

2. The Related Technology

Gravity and magnetic surveys are widely used in geophysical exploration and other applications. These surveys are typically based on measurements of the gravity and/or magnetic fields, including scalar components such as the total magnetic intensity (TMI), and/or vector components such as the vertical gravity field, and/or tensor (or gradient) components of the gravity or magnetic fields which collectively form the gravity or magnetic tensor fields, respectively.

Airborne gravity and/or magnetic surveys typically contain hundreds to thousands of line kilometers of data with measurement locations every few meters. With the availability of low-cost and reliable instrumentation, effectively every airborne geophysical survey includes measurement of the total magnetic intensity (TMI).

Relative to the large volume of gravity and magnetic data acquired each year, very few 3D inversions are actually performed. This is a reflection of the limited capacity for existing 3D inversion software to invert entire surveys with sufficient model resolution in sufficient time so as to affect exploration decisions. It follows that structural interpretations are usually based on some kind of Euler deconvolution, eigenvector, wavelet, analytic signal, or depth-from-extreme-points method. While such methods may provide information about the sources of the observed gravity and/or magnetic data, it is not immediately obvious how that information can be quantified in terms of 3D density and/or magnetization models. Moreover, this information cannot be delivered in real time in the process of acquiring the airborne data.

It was demonstrated by Zhdanov in U.S. Patent Application No. 20110144472 and by Zhdanov et al., 2010, that rapid imaging of gravity and/or magnetic data can be based on the principles of potential field holography/migration. The method is based on a direct integral transformation of the observed gravity and/or magnetic data into 3D density and/or magnetization models, respectively.

Olsen and Petrick, 1989, introduced airborne survey system for real time collection and processing geophysical data using GPS. However, these raw geophysical data provide the qualitative information only about the geological structures present and cannot be used for direct identification and location of the potential mineral deposits in real time. Therefore, a need exists in geophysical exploration for real-time quantitative interpretation of gravity and/or magnetic data measured from moving platforms.

### BRIEF SUMMARY

At least one embodiment of a method disclosed herein, for example, can be applied for real-time subsurface imaging of geological structures for mineral, hydrocarbons, geothermal and groundwater exploration, unexploded ordinance detection, anti-submarine warfare, and environmental monitoring, using gravity and/or magnetic data acquired from a moving platform such as an airplane, helicopter, airship, unmanned autonomous system, vehicle, boat, or submarine.

An approach based on potential field migration can be applied in principle to gravity and/or magnetic scalar and/or vector and/or tensor data in real time in the process of acquiring the data by a moving platform. In one embodiment, the subsurface geological structures can be imaged in real time by continuous direct transformation of the recorded gravity and/or magnetic data, including scalar and/or vector and/or tensor fields, into a subsurface 3D density and/or magnetization model. The recorded components of the gravity and/or magnetic fields, generated by the subsurface geological structures, can be treated as gravity and/or magnetic “holograms” of the object. Similar to optical and radio wave holography, the volume image of the object may be generally reconstructed by migration of the observed gravity and/or magnetic data toward the object. While in the optical and/or radio-frequency case reconstruction may be performed optically, yielding a visible image, in the case of potential field data, the reconstruction may be performed numerically using a computer transformation.

A migration transformation can be applied in real time to data acquired along survey lines by a moving platform from the start of a survey up to a given time moment t. The result of this migration transformation will generate a temporal holographic image of the subsurface 3D density and/or magnetization model, m(t), located under and near the survey lines. These calculations can be repeated for a sequence of time moments t1<t2< . . . <tn . . . . The corresponding evolution of 3D density and/or magnetization models, m(t1), m(t2), . . . m(tn) . . . , produce a sequence of real-time images of the subsurface geological formations.

The known methods of fast interpretation of gravity and/or magnetic data in geophysics are usually based on some a priori assumptions about the type and properties of the source of the observed field. One advantage of at least one embodiment of real-time holographic imaging of the current disclosure is that it does not use any a priori assumption about the type of the source of the field. A migration transformation may be applied for imaging of arbitrary sources of potential fields.

At least one embodiment of this method can be used in geophysical exploration for mineral resources. Another embodiment of this method can be used for hydrocarbon exploration. Another embodiment of this method can be used for unexploded ordinance detection. Another embodiment of this method can be used for anti-submarine warfare. Yet another embodiment of this method can be used for environmental monitoring.

In practice, reconstruction of a sequence of the real-time holographic images, m(t1), m(t2), . . . m(tn), in accordance with this disclosure may be accomplished numerically, using computer transformation techniques and a central processing unit (CPU) located on the moving platform.

At least one embodiment of a method disclosed herein may be used for applications that determine the distribution of physical parameters, such as the density and/or magnetization, of subsurface geological structures from the gravity and/or magnetic holographic image. In one embodiment, the gravity and/or magnetic data measured at the moving platform locations are used as the values of the conceptual sources of the auxiliary gravity and/or magnetic fields to numerically generate the migration (backpropagating) gravity and/or magnetic field. A spatial weighting of the migration (backpropagating) gravity and/or magnetic fields by an integrated sensitivity may produce a numerical reconstruction of a holographic image of the 3D density and/or magnetization distribution.

Broadly, the disclosure describes a method for rapid real time imaging of density and/or magnetization from moving platforms. The targets may include a mineralization zone or a hydrocarbon reservoir in a case of geophysical exploration, or other geological or man-made objects. The method may include placing from at least one receiver to an array of receivers on the moving platform. The gravity and/or magnetic scalar and/or vector and/or tensor field data produced by the target located in the subsurface geological formations may be recorded by the at least one receiver along the survey lines by the moving platform from the start of the survey up to the given time moment t. The recorded data measured at the at least one receiver from the start of the survey up to the given time moment t, may be applied as an artificial source of the gravity and/or magnetic field to generate an evolving migration (backpropagating) gravity and/or magnetic field for the given time moment t. This evolving gravity and/or magnetic migration field may be obtained empirically and/or by numerical calculation. A spatial weighting of the evolving gravity and/or magnetic migration field by the integrated sensitivity may produce a numerical reconstruction of a temporal holographic image of the part of the 3D density and/or magnetization model, m(t), located under or near the recorded survey lines, providing real time reconstruction of the volume physical properties of the subsurface geological formations. It is possible to improve the resolution of imaging by repeating the transform iteratively.

More specifically, an anomalous target located in an examined survey area may be located and/or characterized through a method of real-time imaging that includes placing a sensor of gravity and/or magnetic scalar and/or vector and/or tensor fields on a moving platform, measuring at least one component of gravity and/or magnetic data with the at least one sensor along the survey lines by the moving platform from the start of the survey up to the given time moment t, conceptually replacing the at least one sensor with at least one corresponding source of the gravity and/or magnetic data, each of the at least one sources having a scalar density and/or scalar susceptibility and/or or vector magnetization which directly corresponds to the at least one measured scalar or vector or tensor field component, obtaining an evolving migration field for the given time moment t, equivalent to that produced by the at least one conceptual source that replaced the at least one actual sensor operating from the start of the survey up to the given time moment t, obtaining an integrated sensitivity of the potential field data acquisition system by estimating a least square norm of values of perturbation of the at least one component of the data at the at least one receiver operating from the start of the survey up to the given time moment t, and producing a temporal holographic image of part of the subsurface 3D density and/or magnetization model, by spatially weighting the migration field.

The gravity and/or magnetic data measured by the at least one sensor may be input to a processor installed on the moving platform. The processor may perform at least one of the following: (1) analyze the measured gravity and/or magnetic data; (2) numerically simulate a conceptual replacement of the sensors with an array of sources of the gravity and/or magnetic fields; (3) compute the evolving gravity and/or magnetic migration field for the given time moment t, equivalent to that produced by the conceptual sources replaced the actual sensors operating from the start of the survey up to the given time moment t; (4) compute integrated sensitivity of the gravity and/or magnetic fields for the given time moment t to the variations of density or magnetization at a specific local area of the examined medium; and (4) constructing a temporal holographic image of the density and/or magnetization distribution for the given time moment t, by calculating spatially weighted migration fields.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1A illustrates an embodiment of a system for real time imaging of density and/or magnetization including a gravity and/or magnetic sensor system placed on the moving platform.

FIG. 1B illustrates an embodiment of a processor or computing system for producing an image according to embodiments disclosed herein.

FIG. 2 illustrates an embodiment of a method for real-time imaging from the moving platform using the embodiment of the system of gravity and/or magnetic sensors of FIG. 1 according to present disclosure.

FIG. 3 illustrates an embodiment of a typical observation system of magnetic field sensors SX located on an observational surface S above a domain V that is filled by magnetic sources characterized by their magnetic susceptibility, χ(r).

FIG. 4 presents a 3D view of an embodiment of two rectangular magnetized parallelepipeds with side dimensions of 100 m in Northing, 200 m in Easting, and 100 m in depth, of 0.05 susceptibility, located 100 m below the surface. Synthetic total magnetic intensity (TMI) field data were computed along ten profiles at 0 m elevation, shown by the dashed lines labeled Line 1 to Line 10.

FIG. 5 panel a, shows a plan view of ten profiles of observation, shown by the dashed lines labeled Line 1 to Line 10. FIG. 5, panel b, shows a plan view of the perimeters of the rectangular magnetized parallelepipeds shown in FIG. 4 superimposed over a map of the synthetic TMI data measured along the ten profiles of observation.

FIG. 6 presents the plots of the TMI field generated using an embodiment of a system and a method for imaging an object along line 2 of the synthetic airborne survey data (the top panel). The bottom panel generally shows the holographic image generated for this profile. The white line generally shows the contours of the vertical sections of the magnetized parallelepipeds.

FIG. 7 shows the real-time evolution of the holographic image of the magnetization distribution by showing horizontal sections of the volume image of the magnetization distribution produced using 2 (panels a and b), 4 (panels c and d), 6 (panels e and f), 8 (panels g and h), and 10 (panels i and j) lines of the synthetic TMI data.

### DETAILED DESCRIPTION

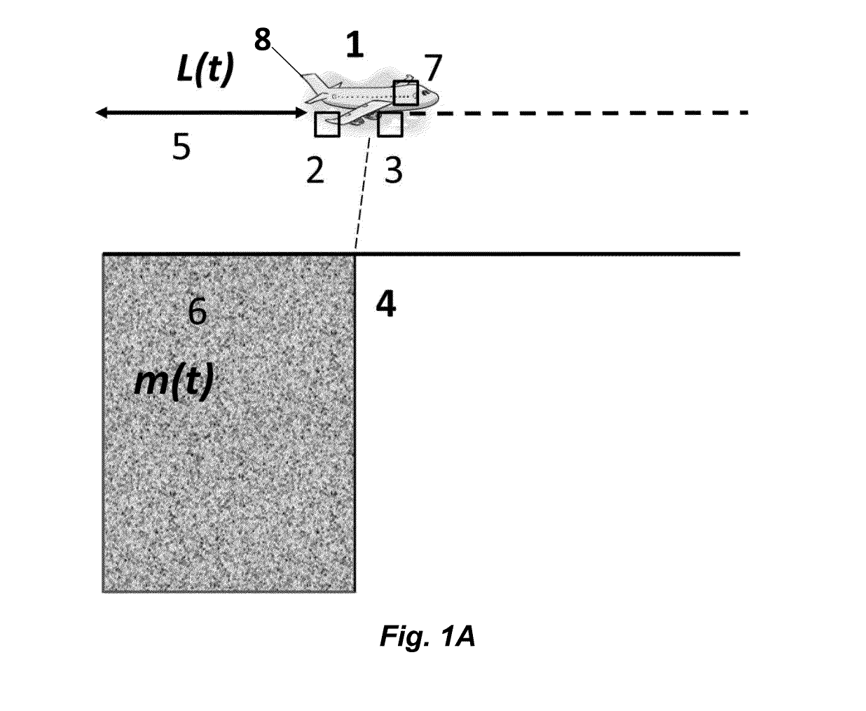

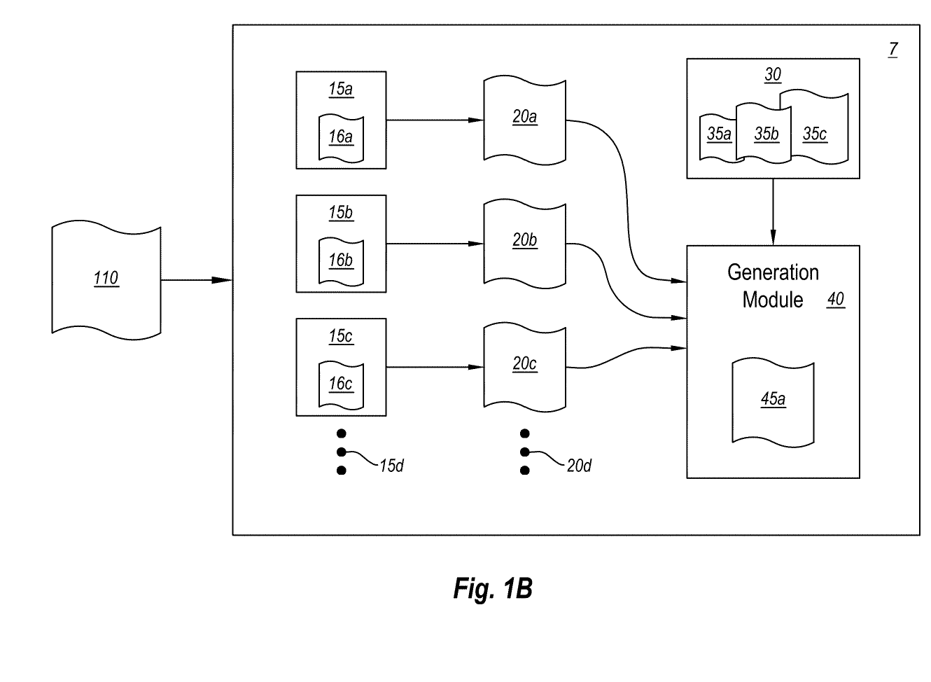

One embodiment of a system for rapid real time gravity and/or magnetic holographic imaging using devices that measure gravity and/or magnetic scalar and/or vector, and/or tensor data from moving platforms is illustrated in FIG. 1A, which illustrates an embodiment of an imaging system 1. The imaging system 1, located on the moving platform 8 such as an airplane, may include gravity field sensors 2 and/or magnetic field sensors 3 placed on the moving platform that is moving at some elevation above the surface of an examined medium 4.

In the embodiment, the gravity field sensors 2 and/or the magnetic field sensors 3 may record the components of the gravity and/or magnetic fields or of their gradients, generated by the subsurface geological formations, along survey line 5 (L(t)) flown over by the moving platform 8 from the start of the survey up to a given time moment t. The migration transformation may be applied in real time to the data collected along the survey line 5 L(t) flown over by the moving platform 8 from the start of the survey up to the given time moment t. The result of this transformation will generate a temporal holographic image of a part 6 of the subsurface 3D density and/or magnetization model, m(t), located directly under the survey line (or area) flown over from the start of the survey up to the given time moment t.

A processor 7, which may include, for example, a central processing unit, may operate the gravity and/or magnetic holographic imaging system. In some embodiments, the processor 7 may be located at the moving platform 8.

FIG. 1B illustrates an example embodiment of the processor 7, which in this embodiment may be a computing system that is able to perform various operations for producing a temporal holographic image in accordance with the principles of the embodiments disclosed herein. As shown, processor 7 receives measured components of the gravity and/or magnetic fields 110 from at least one of the gravity sensors 2 and/or magnetic field sensors 3 up to the given time moment t.

The processor 7 may then conceptually replace the at least one gravity field sensors 2 and/or magnetic field sensors 3 with an array of one or more conceptual sources 15a, 15b, and 15c (also referred to herein as conceptual sources 15) of the gravity and/or magnetic fields located in the positions of the sensors 2 and/or 3. The ellipses 15d represent that there may be any number of additional conceptual sources 15 depending on the number of gravity field sensors 2 and/or magnetic field sensors 3 used to measure the gravity and/or magnetic fields 110.

The conceptual sources 15 each include a scalar density, and/or scalar susceptibility, and/or vector magnetization 16a, 16b, and 16c which directly correspond to the at least one measured gravity field and/or magnetic field component. Said another way, the scalar density, scalar susceptibility, and/or vector magnetization 16a, 16b, and 16c is determined by the actually measured gravity field and/or magnetic field components measured in the locations of the gravity field sensors 2 and/or magnetic field sensors 3.

The processor 5 may then obtain and/or compute evolving migration fields 20a, 20b, 20c (also referred to herein migration fields 20) and potentially any number of additional migration fields as illustrated by the ellipses 20d for the given time moment t.

As illustrated in FIG. 1B, the processor 7 includes a sensitivity module 30. The sensitivity module 30 may obtain and/or compute an integrated sensitivity 35a, 35b, 35c of the gravity field sensors 2 and/or magnetic field sensors 3. In one embodiment, the sensitivity module 30 estimates a least square norm of values of perturbations of the measured gravity and/or magnetic data at the locations of the sensors 2 and/or magnetic field sensors 3 up to the given time moment t.

A generation module 40 of the processor 7 may then generate and/or produce an evolving temporal image 45a for the given time moment t by spatially weighting the migration fields.

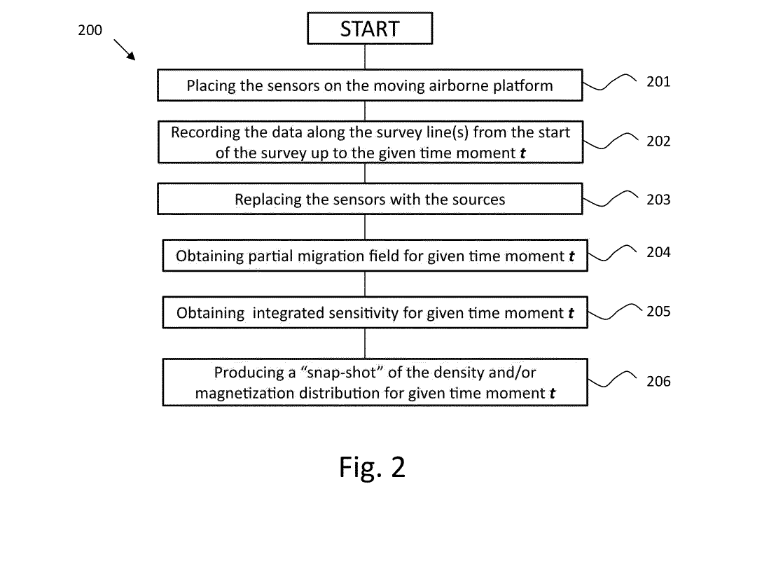

An embodiment of a method 200 for rapid real time imaging density and/or magnetization that may be performed by the imaging system 1 is schematically shown in FIG. 2. The gravity and/or magnetic scalar and/or vector and/or tensor data may be measured by at least one sensor along the survey lines by the moving platform 8 from the start of the survey up to the given time moment t, and may be recorded by the processor 7. In some embodiments, the image reconstruction is numerically reconstructed. For example, the data recorded by the sensors 2 and/or 3 located at the moving platform 8 shown in FIG. 1, may be applied as an artificial (i.e., conceptual) source of the gravity and/or magnetic fields to generate an evolving migration field for the given time moment t. An integrated sensitivity of the data measured by at least one sensor 2 and/or 3 along the survey lines 5 by the moving platform 8 from the start of the survey up to the given time moment t may be calculated. The processor may produce a numerical reconstruction of a temporal holographic image of the density and/or magnetization distribution by applying spatial weighting of the evolving migration field by an integrated sensitivity.

As illustrated, the method 200 includes at block 201 placing at least one sensor of gravity and/or magnetic scalar and/or vector and/or tensor data in at least one receiving position on a moving platform. For example, the sensors 2 and/or 3 may be placed on the moving platform 8.

The method 200 includes at block 202 measuring at least one component of gravity and/or magnetic scalar and/or vector and/or tensor data with the at least one sensor along one or more survey lines by the moving airborne platform from the start of the survey up to a given time moment t. For example, the sensors 2 and/or 3 may measure the one component of gravity and/or magnetic scalar and/or vector and/or tensor data along the survey line 5 up to the given time.

The method 200 includes at block 203 conceptually replacing the at least one sensor with at least one corresponding source of the gravity and/or magnetic data, each of the at least one sources having a scalar density and/or scalar susceptibility and/or vector magnetization which directly corresponds to the at least one measured scalar and/or vector and/or tensor field components. For example, the processor 7 may replace the measured data from the sensor 2 and/or 3 with the conceptual sources previously described.

The method 200 includes at block 204 obtaining an evolving migration field for the given time moment t equivalent to that produced by the at least one conceptual source that replaced the at least one actual sensor operating from the start of the survey up to the given time moment t. For example processor 7 may obtain the evolving migration field equivalent to the produced by the conceptual sources.

The method 200 includes at block 205 obtaining an integrated sensitivity of the gravity and/or magnetic data acquisition system by estimating a least square norm of values of perturbation of the at least one component of the data at the at least one receiver operating from the start of the survey up to the given time moment t. For example, the processor 7 may obtain the integrated sensitivity of the system 1 by estimating the least square norm of the sensors 2 and/or 3 that are operating at the beginning of the survey.

The method 200 includes at block 206 producing an evolving temporal holographic image of the part of the subsurface 3D density and/or magnetization model for the given time moment t, by spatially weighting the migration field. For example, the processor 7 may produce the holographic image of the part of the surface 6.

In one embodiment of the method, it is possible to improve the resolution of imaging by repeating the previous steps iteratively. This procedure generates a holographic image that is equal to the inverse solution for the subsurface 3D density and/or magnetization.

### Example 1

The following is an example of at least some of the principles of the real time gravity and/or magnetic holographic imaging reconstruction that is offered to assist in the practice of the disclosure. It is not intended thereby to limit the scope of the disclosure to any particular theory of operation or to any field of application.

Consider a model, where total magnetic intensity (TMI) data are measured on a surface S above a domain V that is filled by magnetic sources with the intensity of magnetization I(r). The problem is to determine the magnetic susceptibility distribution, χ(r). In what follows, we adopt the common assumptions that there is no remnant magnetization, that the self-demagnetization effect is negligible, and that the magnetic susceptibility is isotropic. Under such assumptions, the intensity of magnetization is linearly related to an inducing magnetic field, H⁰(r), through the magnetic susceptibility:

I(r)=χ(r)H⁰(r), (1)

where r is the radius vector of a point within the volume V.

It is well known that the anomalous scalar TMI data ΔT generated by the magnetic sources within the volume V can be represented by the linear operator equation. In accordance with Zhdanov (1988), the function ΔT(r′) is defined by the equation:

ΔT(r′)=A(χ)=H⁰∫∫∫((χ(r)/(|r−r′|³))K(r′−r)dv, (2)

where H⁰ is the magnitude of the inducing field, l is a unit vector in the direction of magnetization: H⁰(r)=H⁰l(r), and K is the TMI kernel:

K(r′−r)=((3(l·(r′−r))²)/(|r′−r|²))−1. (3)

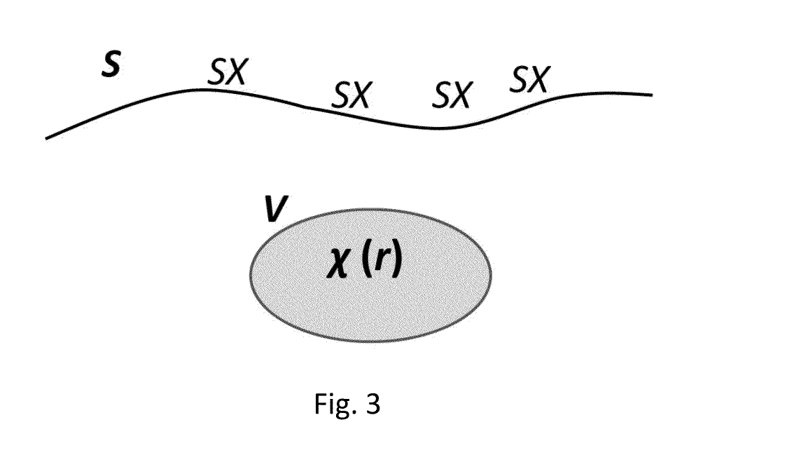

This field may be observed by a system of gravity and/or magnetic sensors SX located on the observational surface S in the proximity and/or above the surface of the examined geological formation. Domain V, which may be filled with the magnetic masses generating the observed field, is located in the lower half-space, as it is shown in FIG. 3.

To generate an image and/or model of the subsurface geological formation, at least one embodiment of a sensor system, such as system 1, may be replaced by one or more conceptual or artificial sources of the magnetic field. The conceptual sources may have the same spatial configuration as may be used for the measuring mode of operation on the observational surface S above the earth surface. Each conceptual source has intensity of magnetization, I(r′), which may be determined by the actually measured TMI according to the following formula:

I(r′)=ΔT(r′)H⁰(r′) (4)

An embodiment of an imaging process of this disclosure includes:

1. Generating the magnetic field produced by the conceptual or artificial sources located in the positions of the sensors with the density determined by formula (4) (backpropagating or “migration” field ΔT^{m} generation). This migration field may be described by the following formula:

ΔT^{m}=H⁰∫∫((ΔT(r′))/(|r′−r|³))K(r′−r)ds′ (5)

2. An integrated sensitivity of the data acquisition system may be obtained by estimating a least square norm of the values of perturbation of the magnetic field, δΔT, due to anomalous susceptibility perturbation δχ at a specific local area of the examined medium according to the following formula:

S(z)=δΔT/δχ. (6)

Formula (6) may be treated as the integrated sensitivity of the TMI data to the local susceptibility located at the depth |z| in the lower half-space (z<0).
3. Producing holographic image by spatially weighting of the migration field ΔT^{m} by the integrated sensitivity S(z).

Referring to FIG. 2, in one embodiment, the operation of imaging system 1 can be summarily formulated as follows. The magnetic field may be recorded by at least one sensor (or by plurality of sensors), placed on the observational surface S above the earth's surface, as indicated in FIG. 3. The processor may analyze the recorded field and may perform at least one of the following numerical processes:

(1) Numerically simulating a system of the conceptual or artificial sources located in the positions of the sensors with the intensity of magnetization, determined by formulae (4).
(2) Computing the migration field, ΔT^{m} simulating the field produced by conceptual or artificial source(s), substituting the at least one sensor.
(3) Determining an integrated sensitivity of the data observation system to the susceptibility variations.
(4) Constructing the holographic images of susceptibility distribution by, for example, calculating a spatial distribution of said migration fields that may be weighted with said integrated sensitivity.

### Example 2

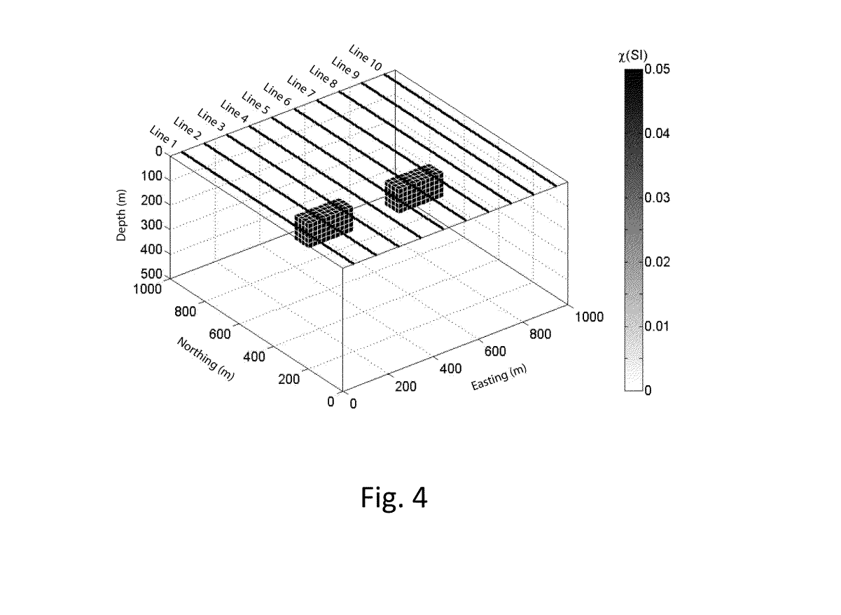

The following is an example simulating the real time imaging of magnetic data. The present embodiment includes a model shown in FIG. 4 formed by a 3D view of an embodiment of two rectangular magnetized parallelepipeds with side dimensions of 100 m in Northing, 200 m in Easting, and 100 m in depth, of 0.05 susceptibility, located 100 m below the surface. The total magnetic intensity (TMI) field data were computed along ten profiles at 0 m elevation, shown by the dashed lines labeled Line 1 to Line 10 (see FIG. 4). Of course, the material shapes, sizes, density, other characteristics, or combinations thereof may vary. The magnetic and/or gravity data may be analyzed along various profiles.

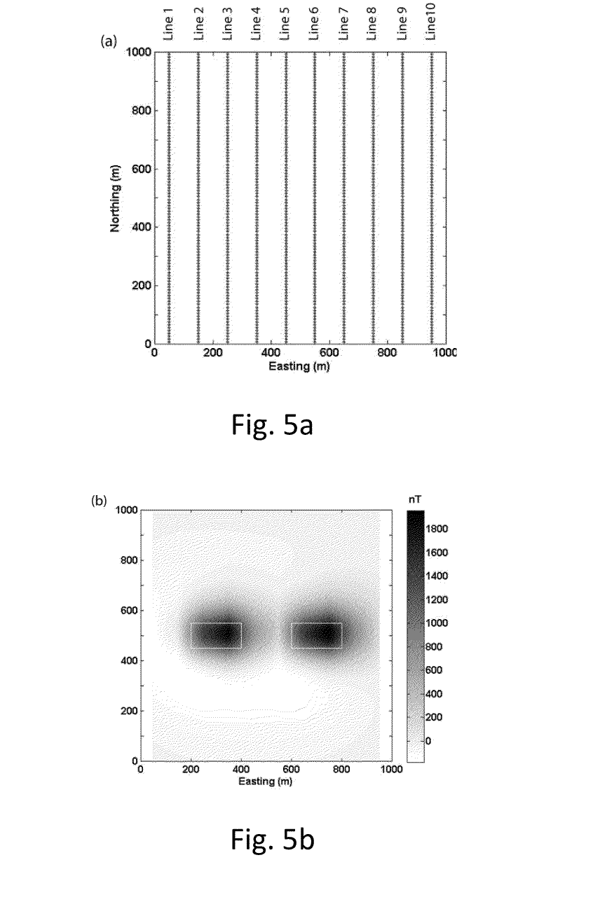

In the present embodiment, the magnetic field data may be analyzed along ten profiles, shown in FIG. 5. The location of the profiles may vary. Other combinations of locations may be used. For example, more and/or fewer profiles may be above the magnetized body, at the edge of the magnetized body, outside of the magnetized body, at other locations and/or orientations, or combinations thereof. The holographic imaging method of the present embodiment may be applied to the observed magnetic field measured along all ten profiles.

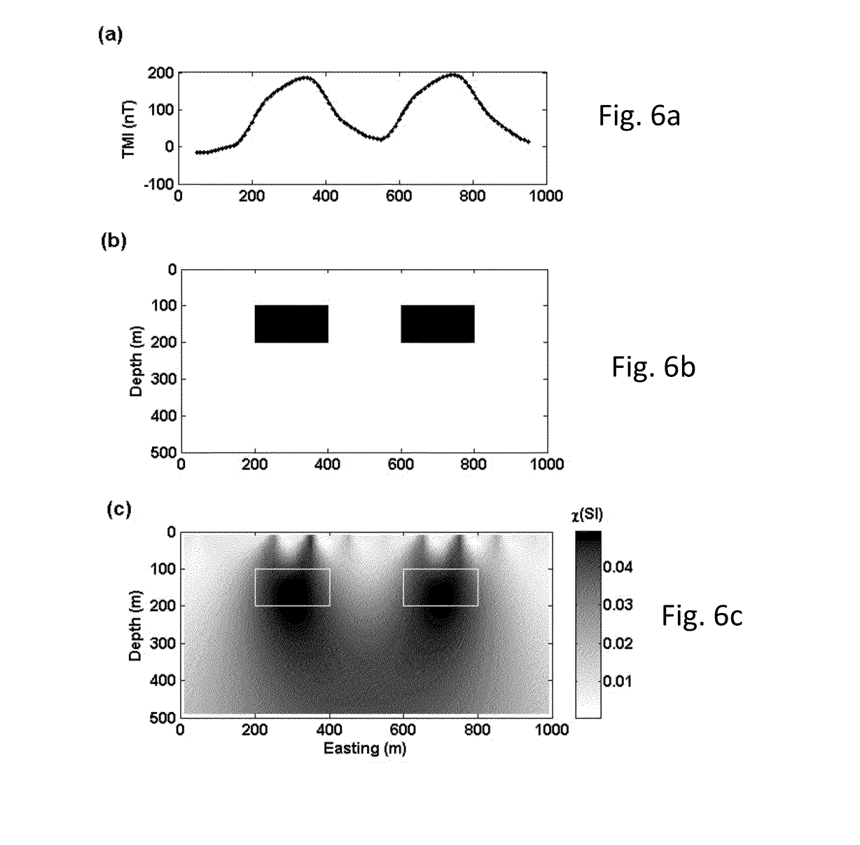

In other embodiments, the imaging method may be applied to the observed magnetic field measured along more and/or fewer profiles. For example, panels (b) and (d) in FIG. 6 present the plots of the TMI data generated using an embodiment of a system and a method for imaging an object along line 2 of the synthetic airborne survey data (the top panel). The bottom panel generally shows the holographic image generated for this profile. The white line generally shows the contours of the vertical sections of the magnetized parallelepipeds. The bottom panel shows an exemplary holographic image generated for this profile.

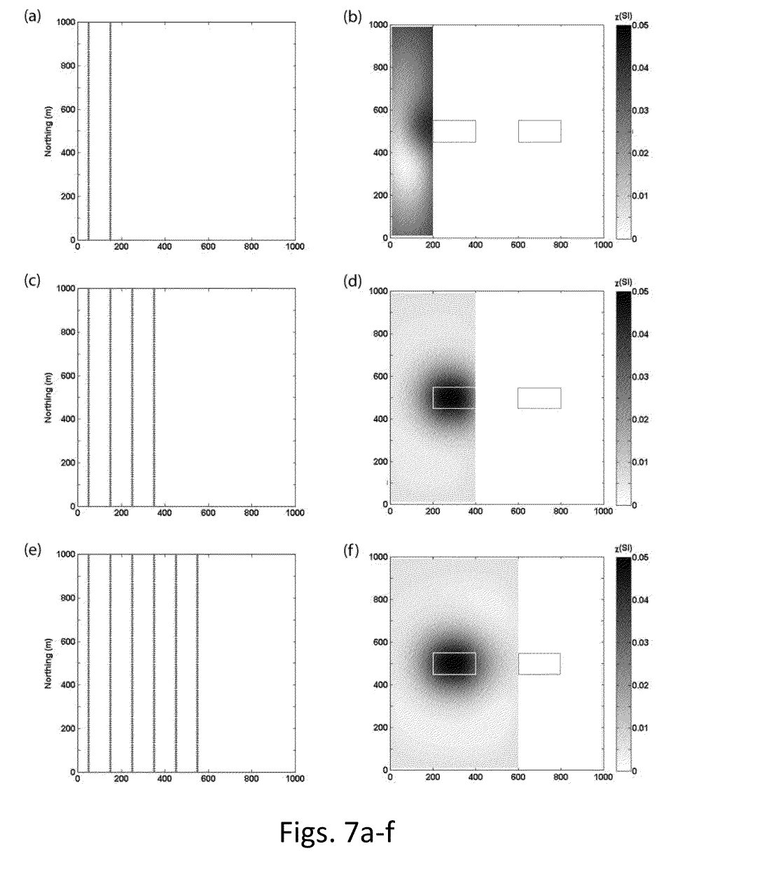

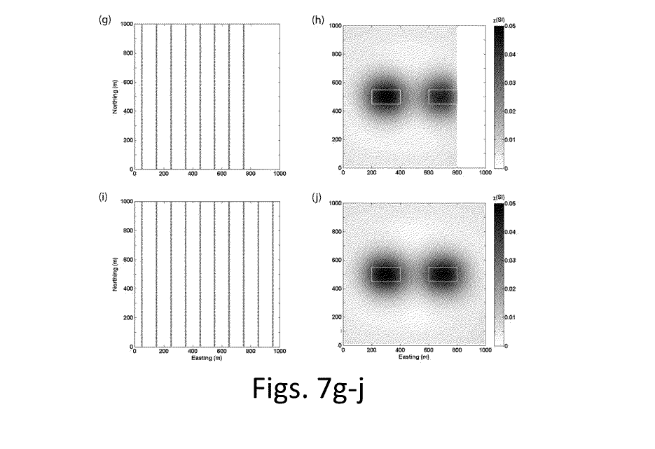

In other embodiments, the imaging method may be applied in real time to the observed magnetic field measured by the at least one receiver along the survey lines by the moving platform from the start of the survey up to the given time moment t. FIG. 7 presents exemplary real-time evolution of the holographic image of the magnetization distribution by showing horizontal sections of the holographic image of the magnetization distribution produced using 2 (panels a and b), 4 (panels c and d), 6 (panels e and f), 8 (panels g and h), and 10 (panels i and j) lines of the synthetic TMI data, respectively. While the images for the first two, four, and six lines (panels a, c, and e, respectively) the images for the first eight and ten lines (panels g and f, respectively) clearly show the second body.

### Example 3

it is possible to improve the resolution of imaging by repeating the steps in the previous examples iteratively. This procedure generates a holographic image that is equal to the inverse solution for the subsurface 3D density and/or magnetization.

The general iterative process can be described by the formula:

mₙ₊₁(r)=mₙ(r)+k(Wₘ*Wₘ)lₙ

where mₙ₊₁(r) is the density and/or magnetization model at the n+1^{th} iteration, mₙ(r) is the density and/or magnetization model at the n^{th} iteration, k is a scalar chosen to optimize the updated model parameters, Wₘ is a model weighting matrix, * denotes the complex conjugate, and lₙ is the regularized direction of steepest decent computed from the application of the adjoint operator on the residual fields.

The regularized direction of steepest decent computed directly from the migration fields described in Example 1.

On every iteration, the following steps are applied:

1. Generating the data produced by the conceptual or artificial sources located in the positions of the sensors with the model parameters (i.e., backpropagating or “migration” field generation).
2. Calculating the residual field between this response and the observed data, and then calculating the iterative migration (“updated backscattering”) field for the updated residual.
3. An integrated sensitivity of the data acquisition system may be obtained by estimating a least square norm of the values of perturbation of the data due to model parameters at a specific local area of the examined medium.
4. Producing an updated holographic image by spatially weighting of the iterative migration field by the integrated sensitivity and a scalar chosen to optimized to minimize the updated residual field.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical non-transitory storage media. Computer-readable media that carry computer-executable instructions are transmission media. Thus, by way of example, and not limitation, embodiments of the invention can comprise at least two distinctly different kinds of computer-readable media: physical non-transitory storage media and transmission media.

Physical non-transitory storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for real time imaging of density and/or magnetization from moving platforms, the method comprising:
a. placing at least one sensor of gravity and/or magnetic scalar and/or vector and/or tensor data in at least one receiving position on a moving platform;
b. measuring at least one field component of gravity and/or magnetic scalar and/or vector and/or tensor data with at least one gravity and/or magnetic scalar and/or vector and/or tensor data sensor in at least one receiving position on the moving platform along one or more survey lines by the moving platform from the start of a survey up to a given time moment t;
c. conceptually replacing the at least one sensor with at least one corresponding source of the gravity and/or magnetic data, each of the at least one sources having a scalar density and/or scalar susceptibility and/or vector magnetization which directly corresponds to the at least one measured scalar and/or vector and/or tensor field components;
d. obtaining an evolving migration field for the given time moment t equivalent to that produced by the at least one conceptual source that replaced the at least one actual sensor operating from the start of the survey up to the given time moment t;
e. obtaining an integrated sensitivity of the gravity and/or magnetic data acquisition system by estimating a least square norm of values of perturbation of the at least one component of the data at the at least one receiver operating from the start of the survey up to the given time moment t;
f. producing an evolving temporal holographic image of the part of the subsurface 3D density and/or magnetization model for the given time moment t, by spatially weighting the migration field.

2. The method of claim 1, wherein the at least one gravity and/or magnetic scalar and/or vector and/or tensor data sensor comprises a plurality of sensors arranged in an array on the moving platform.

3. The method of claim 2, wherein the plurality of sensors include both gravity, and/or gravity gradiometry, and magnetic and/or magnetic gradiometry sensors.

4. The method of claim 1, wherein the measured at least one component of field data is input to a processor, and the processor includes a physical non-transitory storage medium including executable instructions that when executed cause the processor to:
analyze said geophysical field;
compute the evolving migration field by simulating replacing the sensors with an array of sources of the gravity and/or magnetic data, each source with a scalar density and/or scalar susceptibility and/or scalar susceptibility and/or vector magnetization which is determined by the actually measured field components measured along the survey line(s) by the moving platform from the start of the survey up to the given time moment t;
compute integrated sensitivity of the gravity and/or magnetic fields for the given time moment t to the variations of density and/or magnetization at a specific local area of the examined medium;
and construct an evolving temporal holographic image of the volume image of the density and/or magnetization distribution for the given time moment t, by calculating spatially weighted migration fields.

5. The method of claim 1, wherein the moving platform is an airborne platform.

6. The method of claim 1, wherein the method is used in one or more of geophysical exploration for mineral resources, unexploded ordinance detection; anti-submarine warfare, or environmental monitoring.

7. The method of claim 1, wherein the imaging is applied iteratively.

8. A physical non-transitory computer readable medium having stored thereon computer executable instructions that when executed by a processor cause a computing system to perform a method for rapid real time imaging of density and/or magnetization from moving platforms, comprising:
conceptually replacing at least one field component of gravity and/or magnetic scalar and/or vector and/or tensor data measured with the at least one sensor along one or more survey lines by a moving platform from the start of a survey up to a given time moment t with at least one corresponding source of the gravity and/or magnetic data, each of the at least one sources having a scalar density and/or scalar susceptibility and/or vector magnetization which directly corresponds to the at least one measured scalar and/or vector and/or tensor field components;
obtaining an evolving migration field for the given time moment t equivalent to that produced by the at least one conceptual source that replaced the at least one actual sensor operating from the start of the survey up to the given time moment t;
obtaining an integrated sensitivity of the gravity and/or magnetic data acquisition system by estimating a least square norm of values of perturbation of the at least one component of the data at the at least one receiver operating from the start of the survey up to the given time moment t;
producing an evolving temporal holographic image of the part of the subsurface 3D density and/or magnetization model for the given time moment t, by spatially weighting the migration field.

9. The computer readable medium of claim 7, further comprising measuring the at least one field component of gravity and/or magnetic scalar and/or vector and/or tensor data with at least one gravity and/or magnetic scalar and/or vector and/or tensor data sensor in at least one receiving position on the moving platform along one or more survey lines by the moving platform from the start of a survey up to a given time moment t;

10. The computer readable medium of claim 8, wherein the at least one gravity and/or magnetic scalar and/or vector and/or tensor data sensor comprises a plurality of sensors arranged in an array on the moving platform.

11. The computer readable medium of claim 9, wherein the plurality of sensors include both gravity, and/or gravity gradiometry, and magnetic and/or magnetic gradiometry sensors.

12. The computer readable medium of claim 7, wherein the moving platform is an airborne platform.

13. The computer readable medium of claim 7, wherein the computer readable medium is used in one or more of geophysical exploration for mineral resources, unexploded ordinance detection; anti-submarine warfare, or environmental monitoring.

14. A system for real time imaging of density and/or magnetization comprising:
a moving platform;
one or more sensors located at the moving platform, the one or more sensors configured to measure at least one field component of gravity and/or magnetic scalar and/or vector and/or tensor data along one or more survey lines by the moving platform from the start of a survey up to a given time moment t; and
a computing system, the computing system including:
a processor; and
one or more physical non-transitory computer readable medium having computer executable instructions stored thereon that when executed by the processor, cause the computing system to perform the following:
conceptually replace at least one field component of gravity and/or magnetic scalar and/or vector and/or tensor data measured with the on or more sensors along one or more survey lines by the moving platform from the start of a survey up to a given time moment t with at least one corresponding source of the gravity and/or magnetic data, each of the at least one sources having a scalar density and/or scalar susceptibility and/or vector magnetization which directly corresponds to the at least one measured scalar and/or vector and/or tensor field components;
obtain an evolving migration field for the given time moment t equivalent to that produced by the at least one conceptual source that replaced the at least one actual sensor operating from the start of the survey up to the given time moment t;
obtain an integrated sensitivity of the gravity and/or magnetic data acquisition system by estimating a least square norm of values of perturbation of the at least one component of the data at the at least one receiver operating from the start of the survey up to the given time moment t;
produce an evolving temporal holographic image of the part of the subsurface 3D density and/or magnetization model for the given time moment t, by spatially weighting the migration field.

15. The system of claim 14, wherein the moving platform is an airborne platform.

16. The system of claim 15, wherein the airborne platform is one of an airplane, helicopter, or unmanned aerial system.

17. The system of claim 14, wherein the one or more sensors comprises a plurality of sensors arranged in an array on the moving platform.

18. The system of claim 17, wherein the plurality of sensors include gravity and/or gravity gradiometry, and magnetic and/or magnetic gradiometry sensors.

19. The system of claim 14, wherein the system is used in one or more of geophysical exploration for mineral resources, unexploded ordinance detection; anti-submarine warfare, or environmental monitoring.
